(19) United States
(12) Patent Application Publication
(10) Pub. No.: US 2024/0377360 A1
(43) Pub. Date: Nov. 14, 2024

(54) Scanning System and Method for Axial Symmetric Test Objects

(71) Applicant: JENTEK Sensors, Inc., Marlborough, MA (US)

(72) Inventors: Todd M Dunford, Amherst, MA (US); Neil J. Goldfine, Cocoa Beach, FL (US); Jared Nelms, Melbourne, FL (US); Matthew Helseth, Orlando, FL (US)

(73) Assignee: JENTEK Sensors, Inc., Marlborough, MA (US)

(21) Appl. No.: 18/661,553

(22) Filed: May 10, 2024

Related U.S. Application Data
(60) Provisional application No. 63/501,376, filed on May 10, 2023.

(51) Int. Cl. G01N 27/90; G01B 7/02; G01N 27/9013; G01N 27/904; G01N 27/9093

(52) U.S. Cl. CPC G01N 27/9006; G01B 7/023; G01N 27/902; G01N 27/904; G01N 27/9073; G01N 27/9093

(57) ABSTRACT

Axially symmetric objects may require scanning for reasons such as quality inspection, remaining life prediction, and flaw detection. Scanning systems and methods are provided for test objects that may be substantially symmetric about an axis. The scanning system may have curved supports to provide mechanical support to the test object during scanning. The curved support may reduce bending of the test object during scanning and prevent permanent deformation that may otherwise occur during the scanning process. A sensor system may be mounted (at least in part) to a mounting rail such that a sensor may move axially along the rail during a scanning process. Measurement data may be collected and analyzed to assist in determining the disposition of the test object.

### RELATED APPLICATION

The present application claims priority under 35 U.S.C. § 119(e) to U.S. provisional patent application, U.S. Ser. No. 63/501,376 filed May 10, 2023, which is herein incorporated by reference in its entirety.

### BACKGROUND

The various aspects described herein relate to scanning systems and methods of scanning.

### SUMMARY

Axially symmetric objects may require scanning for reasons such as quality inspection, remaining life prediction, and flaw detection. Scanning systems and methods are provided for test objects that may be substantially symmetric about an axis. The scanning system may have curved supports to provide mechanical support to the test object during scanning. The curved support may reduce bending of the test object during scanning and prevent permanent deformation that may otherwise occur during the scanning process. A sensor system may be mounted (at least in part) to a mounting rail such that a sensor may move axially along the rail during a scanning process. Measurement data may be collected and analyzed to assist in determining the disposition of the test object.

One aspect relates to a scanning system for scanning a tubular test object having a tube wall with a plurality of diameter surfaces that include an inside diameter surface and an outside diameter surface. The scanning system comprises a first end support; a second end support; a curved support mechanically supported by the first and second end supports, and having a curved surface for supporting the tubular test object on at least one of the plurality of diameter surfaces; a mounting rail mechanically supported by the first and second end supports and running parallel to the curved support; and a sensor system holder mechanically supported by the mounting rail and movable along the mounting rail.

In some embodiments of the scanning system, the curved surface of the curved support is a convex surface for supporting the tubular test object on the inside diameter surface.

In some embodiments, the scanning system further comprises a sensor system at least a portion of which is mechanically supported by the sensor system holder, the at least a portion including a flexible sensor; wherein the mounting rail is mechanically supported by the first and second end supports such that the sensor system holder, in a first location, positions the flexible sensor opposite the curved surface of the curved support, such that during scanning operation a portion of the tube wall of the tubular test object is between the curved support and the flexible sensor.

In some embodiments of the scanning system, the curved surface is a convex curved surface positioned to provide support on the inside diameter surface of the tubular test object; and the flexible sensor is positioned such that during scanning operation the flexible sensor scans on the outside diameter surface of the tube wall of the tubular test object.

In some embodiments of the scanning system, the curved surface is a concave curved surface positioned to provide support on the outside diameter surface of the tubular test object; and the flexible sensor is positioned such that during scanning operation the flexible sensor scans on the inside diameter surface of the tube wall of the tubular test object.

In some embodiments of the scanning system, the curved support is a first curved support; and the first curved surface is a convex curved surface positioned to provide support on the inside diameter surface of the tubular test object; and the scanning system further comprises
a second curved support mechanically supported by the first and second end supports and running parallel to the first curved support, the second curved support positioned to provide support on the outside diameter surface of the tubular test object;

In some embodiments of the scanning system, the first curved support and the second curved support are positioned such that the convex curved surface and the concave curved surface are concentric about an axis; the sensor system holder is a first sensor system holder; the mounting rail is a first mounting rail; and the first mounting rail supports the first sensor system holder at a larger radial distance from the axis than the convex curved surface; and the scanning system further comprises a second mounting rail mechanically supported by the first and second end supports and running parallel to the second curved support; and a second sensor system holder mechanically supported by the second mounting rail and movable along the second mounting rail, the second sensor system holder supported by the second mounting rail at a smaller radial distance from the axis than the concave curved surface.

In some embodiments of the scanning system, the curved surface of the curved support is substantially radially symmetric such that a radial axis is defined; and the scanning system further comprises a clamp mechanically supported by the first and second end supports, the clamp having a stationary portion at a smaller radial position about the radial axis and a sliding portion at a larger radial position about the radial axis.

In some embodiments of the scanning system, the first and second end supports each have a flat surface substantially within a same plane defining a bottom of the scanning system; the radial axis is offset from the plane; and the clamp is positioned between 30 and 90 degrees about the radial axis where 0 degrees is defined by a line normal to the plane and intersecting the radial axis.

In some embodiments, the scanning system further comprises a motor for moving the sensor system holder along the mounting rail.

Another aspect relates to a method of inspecting a tubular test object having a tube wall with a plurality of diameter surfaces. The method comprises acts of (i) providing a scanning system having a first end support; a second end support; a curved support mechanically supported by the first and second end supports, and having a curved surface; a mounting rail mechanically supported by the first and second end supports and running parallel to the curved support; a sensor system holder mechanically supported by the mounting rail and movable along the mounting rail; and a sensor system at least a portion of which is mechanically supported by the sensor system holder, the at least a portion including a flexible sensor; (ii) loading the scanning system with the tubular test object such that the curved support supports the tubular test object on a first diameter surface among the plurality of diameter surfaces and a portion of the tube wall in contact with the curved support is between the flexible sensor and the curved support; and (iii) measuring with the sensor system while scanning the flexible sensor along a second diameter surface among the plurality of diameter surfaces, the second diameter surface different from the first diameter surface.

In some embodiments of the method, the curved surface is a convex curved surface; the first diameter surface is an inside diameter surface of the tubular test object; and the second diameter surface is an outside diameter surface of the tubular test object.

In some embodiments of the method, the curved surface is a concave curved surface; the first diameter surface is an outside diameter surface of the tubular test object; and the second diameter surface is an inside diameter surface of the tubular test object.

In some embodiments of the method, the scanning of act (iii) is achieved by rotating the tubular test object about its axis.

In some embodiments of the method, the scanning of act (iii) is achieved by moving the sensor system holder along the mounting rail.

In some embodiments of the method, the flexible sensor is a flexible eddy current array; the sensor system includes an eddy current array instrument operably connected to the flexible eddy current array; the sensor system holder applies a force to press the flexible eddy current array against the second diameter surface; and the curved support provides an opposite force to prevent radial deformation of the test object during act (iii).

In some embodiments of the method, the flexible sensor is a flexible eddy current array having a drive winding and an array of sense windings, the drive winding having a linear portion, and a drive-sense gap is defined as the minimum distance between the linear portion of the drive winding and the array of sense windings; and the method further comprises (iv) processing measurements from the flexible sensor to estimate a plurality of properties including liftoff; and (v) filtering out measurements collected at locations where the sensor liftoff exceeds the drive-sense gap.

In some embodiments of the method, the drive winding has a dual rectangle drive construct. In some embodiments of the method, the drive winding has a single rectangle drive construct.

In some embodiments of the method, the act (i) of providing the scanning system comprises providing a second mounting rail, a second sensor system holder, and a second sensor system; and the act (iii) further comprises measuring and scanning with the second sensor system on the first diameter surface.

In some embodiments of the method, the act (ii) of loading the scanning system with the tubular test object comprises clamping the tubular test object with a clamp having a stationary portion within an inside diameter of the tubular test object a sliding portion at an outside diameter of the tubular test object.

In some embodiments of the method, the act (iii) comprises scanning along a seam weld.

In some embodiments of the method, the flexible sensor is a flexible eddy current array having an array of sense element; and the act (iii) comprises positioning the flexible eddy current array on the seam weld such that the array of sense elements spans a width of the seam weld and positions sense elements on base material on each side of the seam weld.

In some embodiments of the method, the flexible sensor is a flexible eddy current array;

the sensor system includes an eddy current array instrument operably connected to the flexible eddy current array; and the act (iii) comprises exciting the flexible eddy current array with the eddy current array instrument at an excitation frequency such that a skin depth at the excitation frequency at a location on the tubular test object being measured by the flexible eddy current array is less than a wall thickness of the tube wall at the location.

In some embodiments of the method, the flexible sensor is a flexible eddy current array having a linear drive construct; and act (iii) comprises orienting the linear drive construct at 45 degrees relative to a direction of scanning, the method further comprising rotating the flexible eddy current array such that the linear drive construct is oriented at minus 45 degrees relative to the direction of scanning and repeating acts (iii) and (iv).

Yet another aspect relates to an apparatus for holding a eddy current sensor in proximity to a welded sample. The apparatus comprises an eddy current instrument with a connector at one end; a holder for the eddy current instrument; a mounting arm with a first mechanical connector for attaching the holder on one end a second mechanical connector for connecting to a structure that is separate from the welded sample; an eddy current array having at least three sensing elements, the eddy current array operably connected to the eddy current instrument, wherein the eddy current array scan width is larger than the weld width; a first mechanism for adjusting the eddy current array to be substantially tangent to a surface of the welded sample; a module for determining, at a start of a scan, that at least one sensing element on each end of the eddy current array is sensing base material outside of a weld on the welded sample; and a second mechanism for moving the eddy current array instrument away from the sample to enable welding to be performed on the welded sample, where the second mechanism enables the eddy current instrument and the eddy current array to be at a distance from the welding process sufficient to avoid damage from the welding process.

In some embodiments, the apparatus further comprises an actuator for providing relative motion between the eddy current instrument and the welded sample.

In some embodiments, the apparatus further comprises a third mechanism for adjusting a transverse position of the eddy current array to ensure that at least one sensing element on each end of the eddy current array is sensing base material outside of a weld on the welded sample.

In some embodiments of the apparatus the module controls the third mechanism to adjust the transverse position based on a response of the eddy current array.

In some embodiments of the apparatus the module further verifies that the at least one sensing element on each end of the eddy current array is sensing base material outside of the weld throughout the scan.

In some embodiments of the apparatus the eddy current array has a drive winding having a linear drive segment, and the at least three sensing elements each have a same distance from the linear drive segment.

In some embodiments, the apparatus further comprises a sensor rotating mechanism for rotating and locking the eddy current array at angles of +45 degrees and −45 degrees relative to a direction of the weld.

In some embodiments of the apparatus the eddy current array is a first eddy current sensor array, the first eddy current sensor array oriented at +45 degrees relative to a direction of the weld, the apparatus further comprising a second eddy current array oriented at −45 degrees relative to a direction of the weld.

In some embodiments of the apparatus a liftoff of the sensor is determined using a precomputed database, . . . the maximum liftoff is below a prescribed value.

In some embodiments of the apparatus at least one excitation frequency is used with a skin depth less than a thickness of the weld sample for detection of near side defects in the weld or immediately adjacent base material.

In some embodiments of the apparatus at least one other excitation frequency is used with a skin depth greater than a thickness of the weld sample for detection of far side defects in the weld or immediately adjacent base material.

In some embodiments of the apparatus at least one excitation frequency is used with a skin depth greater than a thickness of the weld sample for detection of far side defects in the weld or immediately adjacent base material.

In some embodiments of the apparatus a signature is extracted from a simulated defect and used to filter inspection data to determine if defects are present in the welded sample.

In some embodiments of the apparatus signatures are extracted for at least two different defect orientations and each signature is used to filter inspection data to determine if defects are present in the welded sample.

In some embodiments of the apparatus a threshold is set on a C-scan image to enable visualization of defects with responses above a prescribed level.

In some embodiments of the apparatus two images are displayed for the operator, one for near side flaws and one for far side flaws.

In some embodiments of the apparatus two thresholds are set at two different frequencies, one for near side flaws and one for far side flaws.

Yet another aspect relates to an apparatus for aligning a flexible eddy current array for inspection of an axially symmetric thin walled, circumferentially welded part. The apparatus comprises a conformable eddy current array having at least three sensing elements and a flexible backing material, wherein the eddy current array scan width is larger than a weld width; an actuator for providing relative motion between the eddy current array and the welded sample; a module for determining, at a start of a scan, that at least one sensing element on each end of the eddy current array is sensing base material outside of a weld on the welded sample; a mechanism for adjusting a transverse position of the eddy current array to ensure that at least one sensing element on each end of the eddy current array is sensing base material outside of a weld on the welded sample.

Yet another aspect relates to an apparatus for holding a thin walled cylinder comprising a frame having a base; a support to maintain a shape of the cylinder; a first curved support attached to the frame for providing mechanical support on an inside arc of the cylinder for a majority of a length of the cylinder; a second curved support attached to the frame for providing mechanical support on an outside arc of the cylinder; a clamp attached to the frame having a stationary portion inside the cylinder and a sliding portion outside the cylinder to slide radially to secure the cylinder in an axial direction.

The foregoing is a non-limiting summary of the invention, which is defined by the attached claims.

### BRIEF DESCRIPTION OF THE DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is block diagram of a system for inspecting a test object, according to some embodiments;

FIGS. 1B-C show eddy current array sensors, according to some embodiments;

FIG. 2 is a block diagram of an instrument for measuring and analyzing sensor measurements, according to some embodiments;

FIGS. 3A-3I show views of the tube scanner, according to some embodiments; and

FIGS. 4A-4F show views of a scanning system, according to some embodiments.

### DETAILED DESCRIPTION

The inventors have recognized and appreciated that improved scanners are needed for scanning axially symmetric test objects with eddy current or other sensor modalities. Such measurement data can be a critical part of, for example, validating manufacturing quality, inspections to characterize defects and remaining useful life, and for scrap, rework, or repair decisions.

Section I provides an overview of a measurement system that may be used in some embodiments. Section II describes, at least in part, a scanning system for substantially tubular test objects, according to some embodiments. Section III describes, at least in part, a scanning system for axially symmetric test objects. Section IV provides a closing discussion.

### SECTION I—SYSTEM OVERVIEW

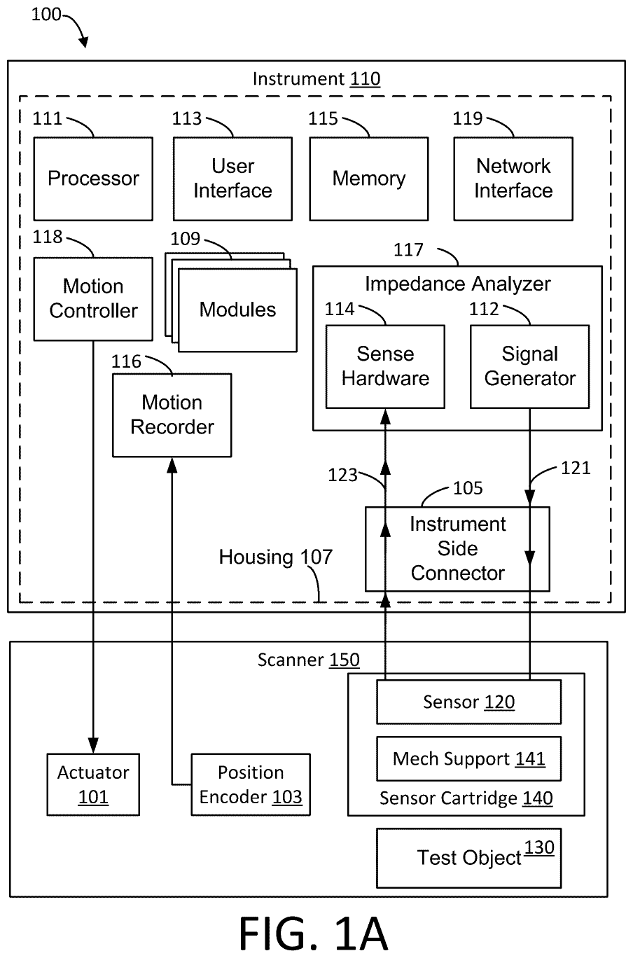

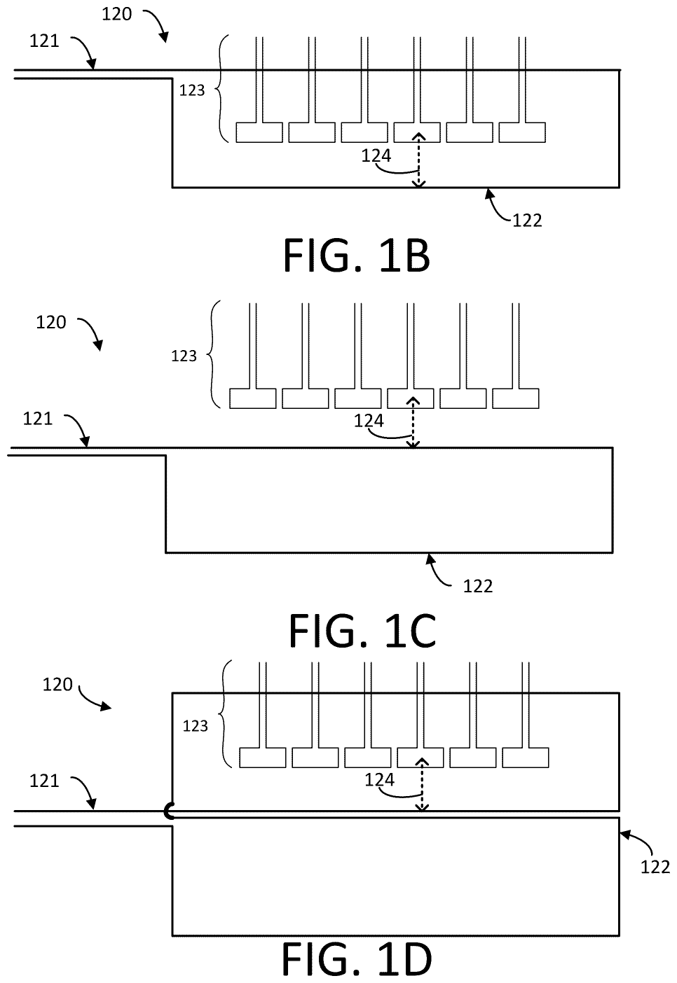

Aspects of some embodiments relate to the use of a system 100 for inspecting a test object 130. System 100 is shown as a block diagram in FIG. 1A. System 100 includes an instrument 110 and a sensor cartridge 140. In some embodiments, system 100 includes a scanner 150 for providing mechanical support for instrument 110, sensor cartridge 140, and/or test object 130 as well as facilitating relative motion between sensor cartridge 140 and test object 130.

Instrument 110 may be housed in a housing 107; in some embodiments the housing is substantially cylindrical in shape such as that described in U.S. Pat. No. 10,416,118, Measurement system and method of use, by Goldfine et al. issued Sep. 17, 2019 and herein incorporated by reference in its entirety (the '118 patent). Sensor cartridge 140 may have a rigid connector which interfaces both mechanically and electrically with an instrument side connector 105.

In some embodiments, sensor cartridge 140 is connected to instrument side connector 105 via cable 150. Cable 150 may be of arbitrary length in accordance with the requirements of the application. Although cable 150 is shown with only excitation signals 121 and response signals 123 passing through it, it should be appreciated that cable 150 may also convey other signals (including power). For example, power and/or measurement signals for position encoder 103 may be conveyed through cable 150. Similarly, power and/or control signals for actuator 101 may be conveyed through cable 150.

In some other embodiments, sensor 120 is directly connected to instrument side connector 105. Sensor cartridge 140 in some embodiments also includes a flexible sensor 120, and a mechanical support 141 to which the sensor is attached. Sensor 120 may be attached to mechanical support 141 with glue, tape, double sided tape, or in any suitable way. Instrument 110 is configured to provide excitation signals 121 to sensor 120 and measure the resulting response signals 123 of sensor 120. Response signals 123 may be measured and processed to estimate properties of interest, such as electromagnetic properties (e.g., electrical conductivity, permeability, and permittivity), geometric properties (e.g., layer thickness, sensor liftoff), material condition (e.g., fault/no fault, crack size, layer to layer bond integrity, porosity, residual stress level, temperature), or any other suitable property or combination thereof including properties of the fabricated part and the powder. (Sensor liftoff is a distance between the sensor and the closest surface of the test object for which the sensor is sensitive to the test object's electrical properties.)

Instrument 110 may include a processor 111, a user interface 113, memory 115, an impedance analyzer 117, and a network interface 119. Though, in some embodiments of instrument 110 may include other combinations of components. While instrument 110 is drawn with housing 107, it should be appreciated that instrument 110 may be physically realized as a single mechanical enclosure; multiple, operably-connected mechanical enclosures, or in any other suitable way. For example, in some embodiments it may be desired to provide certain components of instrument 110 as proximal to sensor 120 as practical, while other components of instrument 110 may be located at greater distance from sensor 120.

Processor 111 may be configured to control instrument 110 and may be operatively connected to memory 115. Processor 111 may be any suitable processing device such as for example and not limitation, a central processing unit (CPU), digital signal processor (DSP), controller, addressable controller, general or special purpose microprocessor, microcontroller, addressable microprocessor, programmable processor, programmable controller, dedicated processor, dedicated controller, or any suitable processing device. In some embodiments, processor 111 comprises one or more processors, for example, processor 111 may have multiple cores and/or be comprised of multiple microchips. Processing of sensor data and other computations such as for control may be performed sequentially, in parallel, or by some other method or combination of methods.

Memory 115 may be integrated into processor 111 and/or may include “off-chip” memory that may be accessible to processor 111, for example, via a memory bus (not shown). Memory 115 may store software modules that when executed by processor 111 perform desired functions. Memory 115 may be any suitable type of non-transient computer-readable storage medium such as, for example and not limitation, RAM, a nanotechnology-based memory, optical disks, volatile and non-volatile memory devices, magnetic tapes, flash memories, hard disk drive, circuit configurations in Field Programmable Gate Arrays (FPGA), or other semiconductor devices, or other tangible, non-transient computer storage medium.

Instrument 110 may have one or more functional modules 109. Modules 109 may operate to perform specific functions such as processing and analyzing data. Modules 109 may be implemented in hardware, software, or any suitable combination thereof. Memory 115 of instrument 110 may store computer-executable software modules that contain computer-executable instructions. For example, one or more of modules 109 may be stored as computer-executable code in memory 115. These modules may be read for execution by processor 111. Though, this is just an illustrative embodiment and other storage locations and execution means are possible.

Instrument 110 provides excitation signals for sensor 120 and measures the response signal from sensor 120 using impedance analyzer 117. Impedance analyzer 117 may contain a signal generator 112 for providing the excitation signal to sensor 120. Signal generator 112 may provide a suitable voltage and/or current waveform for driving sensor 120. For example, signal generator 112 may provide a sinusoidal signal at one or more selected frequencies, a pulse, a ramp, or any other suitable waveform. Signal generator 112 may provide digital or analog signals and include conversion from one mode to another. The '062 patent provides a discussion of an impedance analyzer that may be used in some embodiments. See, for example, the discussion in connection with FIG. 19a which provides a discussion on how impedance analyzer 117 can take a measurement. The '218 patent provides further discussion on how such impedance measurements may be calibrated to remove certain systematic bias from the measurements.

In some embodiments, impedance analyzer 117 has a current sensor 109 that is used to measure a current leaving signal generator 112. Current sensor 109 may be any suitable sensor for measuring such current. For example, current sensor 109 may include a known series resistance in the drive current signal path and current sensor 109 may measure the voltage across such known resistance such that the current may be calculated using Ohm's Law. As another example, current sensor 109 may measure the voltage induced on an inductive pick-up coil having a well known transimpedance.

Sense hardware 114 may comprise multiple sensing channels for processing multiple sensing element responses in parallel. As there is generally a one to one correspondence between sense elements and instrumentation channels these terms may be used interchangeably. It should be appreciated that care should be used, for example, when multiplexing is used to allow a single channel to measure multiple sense elements. For sensors with a single drive and multiple sensing elements such as the MWM®-Array eddy current array available from JENTEK® Sensors, Inc., the sensing element response may be measured simultaneously at one or multiple frequencies including simultaneous measurement of real and imaginary parts of the transimpedance (or mathematically equivalent measurements/representations such as the magnitude and phase of the transimpedance or the in-phase and quadrature components of the transimpedance). Though, other configurations may be used. For example, sense hardware 114 may comprise multiplexing hardware to facilitate serial processing of the response of multiple sensing elements and for eddy current arrays. Some embodiments of sensor 120 use certain MWM-Array formats to take advantage of the linear drive and the ability to maintain a consistent eddy current pattern across the part using such a linear drive. Sense hardware 114 may measure sensor transimpedance for one or more excitation signals at one or more sense elements 124 of sensor 120. It should be appreciated that while transimpedance (sometimes referred to simply as impedance), may be referred to as the sensor response, the way the sensor response is represented is not critical and any suitable representation may be used. In some embodiments, the output of sense hardware 114 is stored along with temporal information (e.g., a time stamp) to allow for later temporal correlation of the data, and positional data correlation to associate the sensor response with a particular location on test object 130. Instrumentation may also operate in a pulsed mode with time gates used to provide multiple sensing outputs and multiple channels used to acquire data from multiple sensing elements. If these sensing elements 124 have different drive-sense gaps (distance between a drive conductor 122 and the sense elements 124, then this is referred to as a segmented field sensor. Thus, sensor operation can be at a single frequency, multiple frequencies, or in a pulsed mode where the drive is turned on and off in a prescribed manner or switched between two or more modes of excitation.

Sensor 120 is shown as an eddy-current sensor, though other sensor types may be used with system 100. For example, in some embodiments, sensor 120 is one or more of an eddy current sensor, an optical sensor, an ultrasonic testing (UT) sensor, a thermographic sensor, and a radiography sensor.

Sensor 120 has a drive conductor 122, a sense element 124 (or multiple sense elements), and a current sense element 125, each of which is discussed further herein. In some embodiments sensor 120 provides temperature measurement, voltage amplitude measurement, strain sensing or other suitable sensing modalities or combination of sensing modalities. In some embodiments, sensor 120 is an eddy-current sensor such as an MWM, MWM-Rosette, or MWM-Array sensor available from JENTEK Sensors, Inc., Marlborough, MA. A discussion of some MWM-Array sensors may be found. for example, in the '662 patent. Sensor 120 may be a magnetic field sensor or sensor array such as a magnetoresistive sensor (e.g., MR-MWM-Array sensor available from JENTEK Sensors, Inc.), a segmented field MWM sensor, and the like. Segmented field sensors have sensing elements at different distances from the drive winding to enable interrogation of a material to different depths at the same drive input frequency. Sensor 120 may have a single or multiple sensing and drive elements. Sensor 120 may be scanned across, mounted on, or embedded into test object 130.

FIGS. 1B-1C show some eddy current array embodiments of sensor 120. In FIG. 1B, sensor 120 is an eddy current array having an array of sensing elements 123 and a drive winding 121. Drive winding 121 has a single rectangular drive construct 122. Drive construct 122 has a linear segment along which sensing elements 123 are each equidistant. The distance 124, shown as the distance from the nearest linear drive segment to the center of sensor elements may be defined as a drive-sense gap. Other definitions of drive-sense gap may be found in literature or used—for example, the distance between the nearest linear drive segment and the nearest segment of the sense element coil.

In FIG. 1B, sensor 120 has sensing elements 123 within the confines of rectangular drive construct 122. Sensor 120 shown in FIG. 1C is essentially identical to sensor 120 shown in FIG. 1B except that sensing elements 123 outside the confines of rectangular drive construct 122. The drive-sense gap, distance 124, may be defined in the same way for both designs.

In FIG. 1D, sensor 120 has a drive winding 121 where the drive construct 122 is a dual-rectangular drive construct. In some embodiments the dual rectangular drive constructs are connected such that current flows in the same direction in the two adjacent drive segments.

In some embodiments, the computer-executable software modules 109 may include a sensor data processing module that, when executed, estimates properties of test object 130. The sensor data processing module may utilize multi-dimensional precomputed databases that relate one or more frequency transimpedance measurements to properties of test object 130 to be estimated. The generation of suitable databases and the implementation of suitable multivariate inverse methods are described, for example, in U.S. Pat. No. 7,467,057, issued on Dec. 16, 2008 (the '057 patent), and U.S. Pat. No. 8,050,883, issued on Nov. 1, 2011 (the '883 patent), both of which are herein incorporated by reference in their entirety. The sensor data processing module may take the precomputed database and sensor data and, using a multivariate inverse method, estimate material properties for the processed part or the powder. Though, the material properties may be estimated using any other analytical model, empirical model, database, look-up table, or other suitable technique or combination of techniques.

User interface 113 may include devices for interacting with a user. These devices may include, by way of example and not limitation, keypad, pointing device, camera, display, touch screen, audio input and audio output.

Network interface 119 may be any suitable combination of hardware and software configured to communicate over a network. For example, network interface 119 may be implemented as a network interface driver and a network interface card (NIC). The network interface driver may be configured to receive instructions from other components of instrument 110 to perform operations with the NIC. The NIC provides a wired and/or wireless connection to the network. The NIC is configured to generate and receive signals for communication over network. In some embodiments, instrument 110 is distributed among a plurality of networked computing devices. Each computing device may have a network interface for communicating with other computing devices forming instrument 110.

In some embodiments, multiple instruments 110 are used together as part of system 100. Such systems may communicate via their respective network interfaces. In some embodiments, some components are shared among the instruments. For example, a single computer may be used to control all instruments. In one embodiment multiple areas on the test object are scanned using multiple sensors simultaneously or in an otherwise coordinated fashion to use multiple instruments and multiple sensor arrays with multiple integrated connectors to inspect the test object surface faster or more conveniently.

Actuator 101 may be used to position sensor cartridge 140 with respect to test object 130 and ensure that the liftoff of the sensor 120 is in a desired range relative to the test object 130. For example, actuator 101 may drive the movement of mechanical components of scanner 150 that in turn move the sensor 120 relative to test object 130. Actuator 101 may be an electric motor, pneumatic cylinder, hydraulic cylinder, or any other suitable type or combination of types of actuators for facilitating movement of sensor cartridge 140 with respect to test object 130. Actuators 101 may be controlled by motion controller 118. Motion controller 118 may control sensor cartridge 140 to move sensor 120 relative to test object 130.

Regardless of whether motion is controlled by motion controller 118 or directly by the operator, position encoder 103 and motion recorder 116 may be used to record the relative positions of sensor 120 and test object 130. This position information may be recorded with impedance measurements obtained by impedance analyzer 117 so that the impedance data may be spatially registered.

For some applications the performance of system 100 depends (among other things) on the proximity of sensor 120 to test object 130; that is to say the sensor liftoff may be critical to performance for such applications. For example, crack detection in an aerospace application may require cracks 0.5 mm (0.02 inches) in length be reliably detectable in test object 130 (e.g., a turbine disk slot). In order to achieve reliable detection of a small crack, sensor 120's liftoff may need to be kept to under 0.25 mm (0.010 inches). Further, for such an application, sensor 120 may preferably be a sensor array, thus the liftoff of each element in the array may need to be kept to under 0.25 mm (0.010 inches). (It should be appreciated that these dimensions are illustrative and the specific requirements will be dictated by the details of the application.) Measurements may be complicated when test object 130 has a complex curved surface that may change along a measurement scan path.

To permit high-performance operation at higher excitation frequencies, use of current sensor 109 to measure the current in drive conductor 122 may not be sufficient. The inventors have recognized and appreciated that measurement performance may be improved by measuring the current in drive conductor 122 closer to the portion of the drive conductor that is inductively coupling to sense element 124. Specifically, a current sense element 125 located on sensor 120 can be used to much more accurately measure the current in drive conductor 122 that is inductively coupling to sense element 124. This is contrasted with measurement of the drive current much further from sense element 124 using current sensor 109 which is typically within instrument housing 107. Although the electrical impedance of cable 150 may alter the current at the instrument, the local measurement can account for any variation of the current due to the cable.

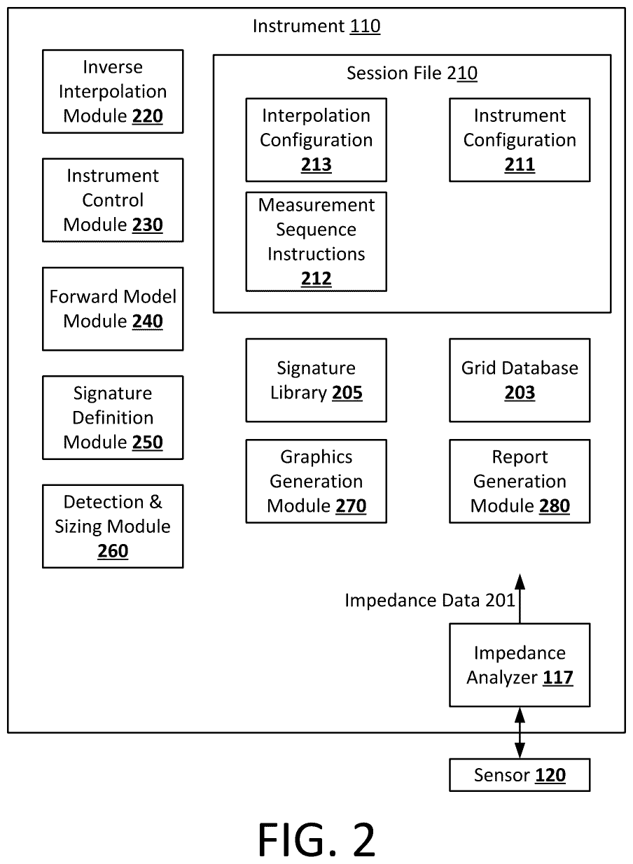

FIG. 2 shows embodiments of instrument 110 with a specific focus on data collection and analysis. It should be appreciated that other aspects of instrument 110 discussed in connection with FIG. 1A or elsewhere may also be part of such an embodiment.

Prior to using instrument 110 to collect and analyze sensor data as part of system 100, instrument 110 may be configured for a specific measurement application. An instrument control module 230 may be used to configure instrument 110 for a specific measurement application. Instrument control module 230 may utilize a session file 210 to store an instrument configuration 211, a measurement sequence instructions 212, and an interpolation configuration 213.

Instrument configuration 211 may store information identifying the type of sensor to be used, the excitation frequencies and their respective amplitudes, specific grids within precomputed database 203 for impedance data interpolation, the type of calibration to be used, the modules that used as part of the measurement such as the specific signatures within signature library 205 for data analysis, and other information for configuring instrument 110 for a measurement application. The calibration typically uses an air calibration or an air with a one point reference measurement calibration. For an air calibration itself, a measurement of the sensor response in air is used to adjust the measurement impedances to known and reproducible values. This approach does not require the use of reference standards for the instrument adjustment, but measurements on a reference part or material is recommended for verification of the calibration itself. To reduce channel-to-channel variations in the sense element responses and improve consistency of the conductivity measurement, a second measurement point can be used as part of the calibration. This second measurement is usually for a reference material with known electrical properties. This provides consistency with other standard procedures for conductivity measurements. Note that one or more reference point measurements could be used but this tends to be less robust than including a measurement response in air since the reference part measurement for calibration requires knowledge of the conductivity of the reference material. The instrument configuration 211 typically also includes information about the data acquisition rate and the configuration of auxiliary information that could be associated with each measurement such as position encoder information, temperature, strain gages, etc.

Measurement sequence instructions 212 may define the sequence of actions that are to take place for a measurement. Instructions 212 may specify motor control, triggers, changes to the instrument configuration, and prompt user actions. For example, instructions 212 may indicate that after initializing a measurement, a first motor is to move at a certain speed during measurement collection and, after reaching an end point, measurement is to stop. As another example, after a first measurement is taken the instructions 212 may indicate the user is to be prompted to take an action (e.g., lay a non-conducting layer between the test object and the sensor to increase sensor liftoff) and then wait until a user initiated trigger is received. As yet another example, after taking first measurements the instructions may cause instrument 110 to be reconfigured to an alternate instrument configuration (e.g., having different excitation frequencies or other configuration properties).

Measurement sequence instructions 212 may also include definitions of the views to be presented to the end user. These views may be read by graphics generation module 270 to affect the graphical presentation to the user. Note that the graphics generation could also be in the form of data tables.

In some embodiments, an inverse interpolation module 220 is used to process impedance data 201 obtained from sensor 120 by impedance analyzer 117. Inverse interpolation module 220 utilizes a grid database 203 to estimate physical properties from impedance data 201. Physical properties estimated may include properties such as layer and gap thicknesses, electrical conductivity as a function of spatial position, and magnetic permeability as a function of spatial position. For example, the physical properties estimated by inverse interpolation module 220 for a sensor scanning a coated substrate material may include (i) liftoff, (ii) coating thickness, (iii) coating electrical conductivity, and (iv) substrate electrical conductivity.

Interpolation configuration 213 of session file 210 may be used to specify aspects of the inverse interpolation. For example, in some embodiments a hierarchical approach can be used to increase numerical stability and accuracy of the multiple unknown inversion. Property effects can be systematically separated from one another by using specific excitation frequencies and/or segmented fields to estimate the properties they are most sensitive to. For example, a coating conductivity property may be estimated using only a high frequency excitation measurement, and then both the high and a low frequency used to determine coating thickness and substrate conductivity (with the coating conductivity in this second step assigned the value determined from the high frequency alone).

Further discussion of the operation of inverse interpolation module 220 may be found in the '057 patent and the '883 patent.

In some embodiments, instrument 110 is also equipped with a forward model module 240 for precomputing grids for grid database 203 using a sensor-material model. The model may be a physics-based model, an empirical model based on prior measurements, or any other suitable type of model for creating measurement grids. In some embodiments, forward model module 240 is not made a part of instrument 110 and only grids are stored in grid database 203 of instrument 110. For example, forward model module 240 may be a software application run on a computer to produce grids which are then stored in grid database 203.

In some embodiments, instrument 110 includes a signature definition module 250 for defining characteristic responses (“signatures”) of a feature to be enhanced or suppressed in measurement data. Signature definition module 250 may allow a user to identify signatures and store them in a signature library; alternatively or additionally, signatures may be identified in an automated or semi-automated way. For example, a crack defect signature may appear in the electrical conductivity response measured by a sensor scanning over the crack. In the case of a sensor array, the response may be observed on a single or multiple adjacent channels. A signature may be identified as a single channel response or a multi-channel response. Signature definition module 250 may standardize signatures prior to storing them in library 205. For example, signatures may be standardized to a specific number of points or a specific amplitude range. Signatures may also include metadata that provide additional information about the signature such as the size of the defect the signature was obtained from.

Detection and sizing module 260 may be used to detect and size defects in measurement data from a test object using signatures from signature library 205. Module 260 may evaluate the correlation between a measurement and a signature. If the correlation exceeds a threshold a detection may be flagged. The threshold may be set based on the detection and false alarm requirements of the application. Signature library 205 may contain multiple signatures that may be tested against measurement data. The signature having the greatest similarity with the measurement may also be used to size a detected defect. For example, the defect size may be estimated to be the same as the size of the defect the signature.

Module 260 may also be used to suppress features that are not of interest such as fasteners or through holes. For example, a through hole in a plate typically has a significant effect on the estimated electrical conductivity of the substrate material if a planar model is used to estimate conductivity. The shape of the conductivity response with respect to position as the sensor is scanned over the hole depends upon the actual electrical conductivity of the substrate material, the excitation frequency, and the geometry (e.g., sense element size and spatial wavelength) of the sensor. However, for a given sensor array, because the conductivity response of the through hole is consistent, it may be removed from the conductivity estimate. For example, module 260 may identify a highly correlated through hole signature with the conductivity response from measurement. The conductivity response may then be updated to remove the signature. This will flatten the conductivity response and may also allow for the hole location to be accurately estimated from the measurement data. While this example discussed suppressing the response for processed data such as the estimated conductivity of the material this approach can also be used for unprocessed data such as the sensor impedance or transinductance.

Graphics generation module 270 may provide a graphical representation to the user to assist the user in the data collection and/or analysis process. Module 270 may present such a graphical presentation on a video display integral to and/or separate from instrument 110. Information may be presented as tables, A-scans, B-scans, C-scans, or any suitable way. In some embodiments, module 270 configures the graphical environment based on instructions 212. In this way a consistent presentation of information can be provided to the user.

Report Generation Module 280 may be included to facilitate review of measurement results outside of the graphical environment of instrument 110. For example, report generation module 280 may produce a report of measurement data in pdf, docx, rtf, xlsx, or other suitable format. Session file 210 may specify the report format which may be used by module 280 to generate reports for measurement data.

In some embodiments, the output includes a decision with regards to the future disposition of the test object. Modules 270 and/or 280 may present such a decision. Examples include pass/fail decisions on the quality of a component, or the presence of flaws. As another example, it may be determined whether the test object may be returned to service, repaired, replaced, scheduled for more or less frequent inspection, and the like. If it is determined that the application was not determinative, instrument 110 may re-perform the procedure (if automated), or advise the user to re-perform the procedure. A procedure may need to be re-performed, for example, if all requirements of the procedure were not met. For example, the procedure may require the liftoff of the sensor to be below a threshold amount over the inspection surface and require re-performance if the liftoff requirement is not met.

In some embodiments the measurement results are used to control a process. For example, a property measurement may be fed back into a control circuit that controls a process.

### SECTION II—SCANNING SYSTEM FOR TUBULAR TEST OBJECTS

The inventors have recognized and appreciated that tube-like structures are common in aerospace, oil and gas, and other industrial and government applications. The inventors have further recognized that such structures may need to be inspected to determine the condition of the structure. Accordingly, a tube scanner and method of use are disclosed to allow efficient and repeatable inspections for tubes.

Herein “tube” is used to refer to a hollow structure having substantially a constant cross section along a main axis. The tube may have a circular cross section along the main axis, although the cross-section may be slightly or substantially out of round in some cases. The tube may be made out of any material or combination of materials including, but not limited, to plastics, metals, ceramics, composites, and combinations thereof. The length of the tube in the direction of its main axis is referred to as the tube's length; the width of the tube is referred to as its diameter. If the tube is non-cylindrical, the tube width may be characterized by a major and minor diameter.

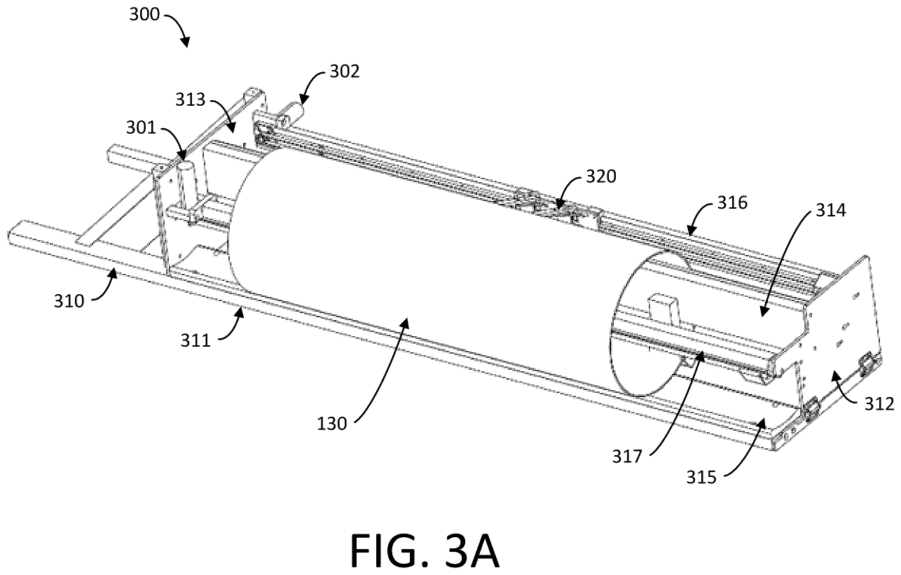

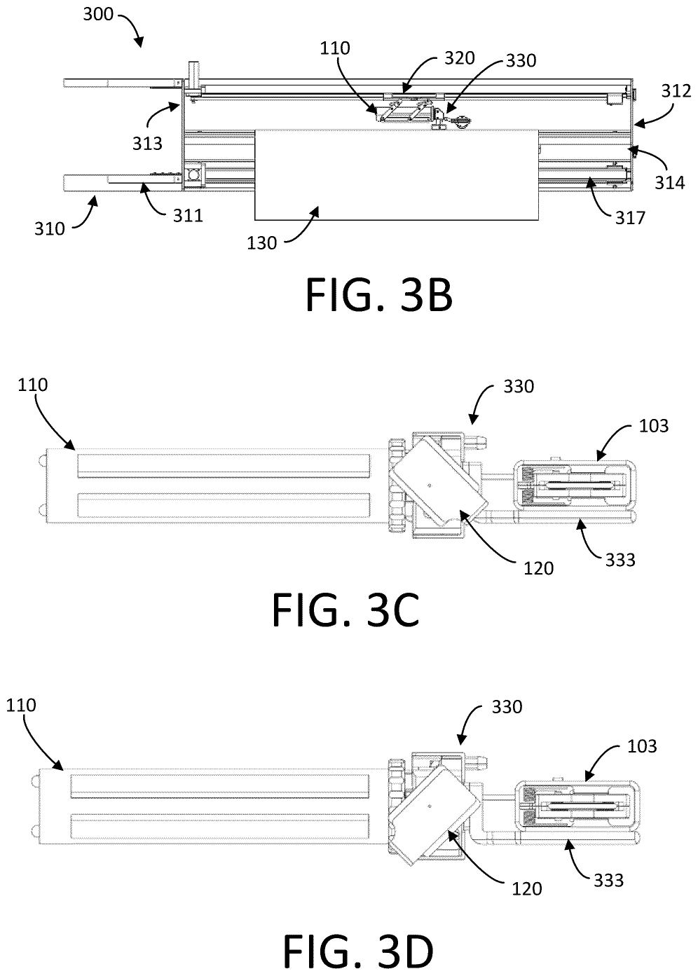

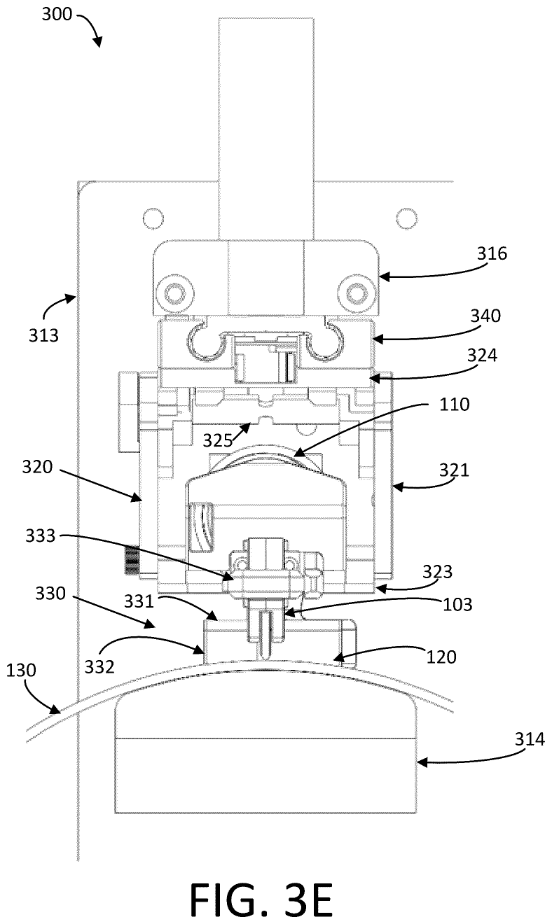

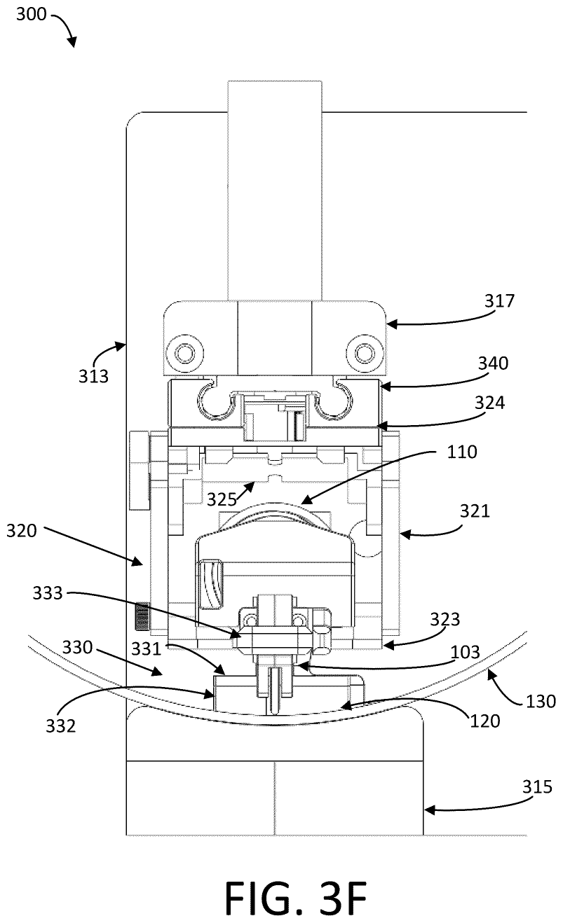

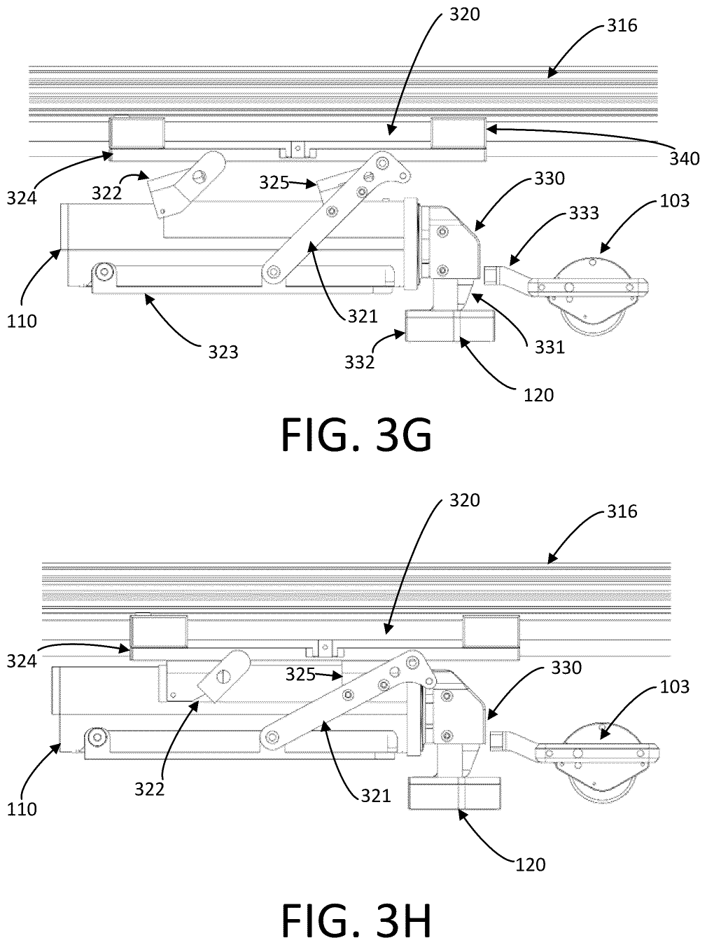

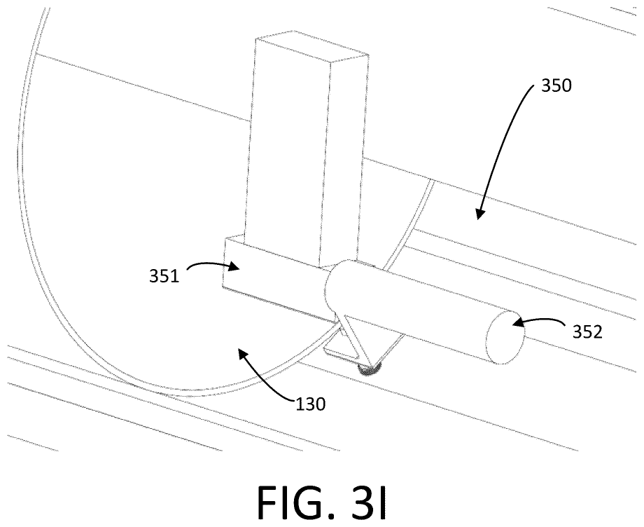

FIGS. 3A-3I show a tube scanner 300, according to some embodiments. Tube scanner 300 may be configured to support scanning of a test object 130 that is tube shaped. Specifically, tube scanner 300 may be used to scan the outer surface of the test object 130, the inner surface of the test object 130, or both. FIGS. 3A, 3B, 3E, 3F, and 3I show scanner 300 with a tubular test object 130 mounted thereon. Scanner 300 may be designed for a maximum and minimum tube length, a maximum and minimum tube diameter, and a maximum out of roundness.

FIG. 3A shows a tube scanner 300 with a tubular scanner structure 310. This tubular scanner structure 310 may provide the requisite components to structurally support the tube scanner 300 as well as the test object 130. Tubular scanner structure 310 includes a scanner frame 311 which may provide the base of other structural components. Tubular scanner structure 310 includes a hinged end support 312 which may be hinged or removable in such a way to allow the placement and removal of test object 130 onto and off of tube scanner 300. Tubular scanner structure 310 includes a static end support 313, as well as both an interior curved support 314 and an exterior curved support 315. Both hinged end support 312 and static end support 313 provide mechanical support for interior curved support 314 and exterior curved support 315 mounted therebetween. Interior curved support 314 may provide mechanical support on the inside of tubular test object 130 while exterior curved support 315 may provide mechanical support on the outside of tubular test object 130. The lengths of interior curved support 314 and exterior curved support 315 may be chosen to accommodate a maximum tube length. Interior curved support 314 and exterior curved support 315 may be interchangeable for different tube lengths or diameters such that the overall size of tube scanner 300 is commensurate with the size of the tubes a particular embodiment is intended to scan.

In some embodiments, hinged end support 312 and static end support 313 may be used with interior curved support 314 and exterior curved support 315 having different geometries (e.g., different lengths or curvatures) such as to reduce the number of scanner elements that may need to be interchanged to adapt scanner 300 to different geometries for test objects 130 (e.g., different length, diameter, or ovality). In this way a modular design may be achieved. hinged end support 312 and static end support 313 may also have multiple mounting positions for interior curved support 314 and/or exterior curved support 315 such that scanner 300 can be configured for tubes of different diameters. For example, if an inspection requires scanner 300 to be brought to a remote site (e.g., a job site) interior curved support 314 and exterior curved support 315 may be selected to have an appropriate length and curvature so that scanner 300 is as easy to transport as practical.

If tubular test object 130 is flexible enough to deform under its own weight, tube scanner 300 may preferably be oriented with exterior curved support 314 located at the bottom of tube scanner 300 (i.e., at the gravitational bottom). In this orientation exterior curved support 314 may provide mechanical support against the weight of a tubular test object 130 installed on tube scanner 300.

Tube scanner 300 includes an exterior mounting rail 316 and an interior mounting rail 317 which allow for the installation of an instrument holding apparatus 320 on either or both simultaneously. Tube scanner 300 may have an interior actuator 301 and/or an exterior actuator 302 which may be used to position instrument holding apparatus 320 at the desired inspection location on a tube. Interior actuator 301 may be used to move instrument holding apparatus relative to the tubular test object 130 axis along the length of the interior mounting rail 317. Exterior actuator 302 may be used to move instrument holding apparatus relative to the tubular test object 130 axis along the length of the exterior mounting rail 316.

Interior actuator 301 and exterior actuator 302 may be an electric motor and may be of a type that maintain a high degree of positional accuracy such that the position of instrument holding apparatus 320 on a tube is maintained and can be recorded automatically with scan data. In some embodiments DC motors are used with position encoders and gearheads for the positional accuracy required for a particular application. Other considerations should be taken into account such as backlash in determining the suitability of the positioning accuracy of the entire system. A position encoder may alternatively or additionally be used to measure the position of instrument holding apparatus 320 in the axial directions.

FIG. 3B shows a top-down view of tube scanner 300 set up to scan the exterior surface of tubular test object 130. Tube scanner 300 has an instrument 110 which is mechanically supported by instrument holding apparatus 320. Tube scanner 300 has a scan head 330 to which a sensor 120 is mounted. Both scan head 330 with sensor 120 attach to instrument 110. Sensor 120 may be any suitable sensor for scanning the exterior surface of tubular test object 130.

FIGS. 3C-D show the instrument 110 with scan head 330 attached sensor 120. A position encoder 103 may be used to accurately track the positional movement of the scan head 330. Scan head 330 may include a position encoder mount 333 to mechanically support the position encoder 103. The orientation of sensor 120 on scan head 330 may be selected based on the goals of the inspection being performed. For example, sensor 120 may be an eddy current sensor array with a shared linear drive. The linear drive may be oriented axially, circumferentially or at an angle between the axial and circumferential orientation such as half way between the two (e.g., +45 degrees, −45 degrees). In some embodiments, scan head 330 can change the orientation of sensor 120 using automation. In some other embodiments, the orientation may be fixed or manually set.

FIGS. 3E-F show tube scanner 300 from an axial viewpoint. FIG. 3E shows instrument holding apparatus 320 attached to exterior mounting rail 316 with scan head 330 and sensor 120 in contact with the outer diameter of tubular test object 130. Interior curved support 314 is positioned as shown such that once a tube is placed on scanner 300 the radial force of scan head 330 against the tube is supported internally by curved support 314. That is the wall of the tube is sandwiched between scan head 330 and interior curved support 314.

FIG. 3F shows instrument holding apparatus 320 attached to interior mounting rail 317 with scan head 330 and sensor 120 in contact with the inner diameter of tubular test object 130. Exterior curved support 315 is positioned as shown such that once a tube is in place on scanner 300 the radial force of scan head 330 against the tube is supported externally by curved support 315. That is the wall of the tube is sandwiched between scan head 330 and exterior curved support 315.

Scan head 330 may have a variable compliance sensor backing 332 for sensor 120 to improve compliance. For example, the backing may have a hardness on the Shore 00, A, or B hardness scales. Any suitable material may be used for backing taking into consideration the sensing modality. Hardnesses ranging from 10 to 60 Shore A may be used with flexible eddy current sensor arrays, though this is merely exemplary and backing material of any suitable hardness may be used.

Scan head 330 has a rotational sensor mount 331 which variable compliance sensor backing 332, and thereby sensor 120, may be affixed to. Rotational sensor mount 331 may be a shaft of some type that allows for changes to the rotational position of the variable compliance sensor backing 332, and thereby sensor 120, with respect to the rest of scan head 330 and thereby the longitudinal axis of tubular test object 130.

Instrument holding apparatus 320 is attached to the translatable rail mount 340. Translatable rail mount 340 may attach to either exterior mounting rail 316 or interior mounting rail 317 via the mechanical mating connection design between them. This mating connection provides rigidity in the radial direction of test object 130 but still provides the ability for motion in the axial direction of test object 130. Translatable rail mount 340 may slide smoothly along the length of exterior mounting rail 316 or interior mounting rail 317 and be stopped at some axial position of test object 130. In some embodiments this sliding motion is manual, in others it may be automated.

FIGS. 3G-3H show scan head 330 attached to instrument 110 which is secured to instrument holding apparatus 320 via the instrument mounting plate 323. Instrument holding apparatus 320 includes a forward hinged arms 321, rear hinged arms 322, and rail mounting plate 324. Rail mounting plate 324 affixes to translatable rail mount 340 and is connected to instrument mounting plate 323, and therefore the instrument 110, via the forward hinged arms 321 and rear hinged arms 322. Both the forward hinged arms 321 and the rear hinged arms 322 may have some spring mechanism 325 to provide consistent outward radial contact between scan head 330 and test object 130. Such a force may be desirable using certain sensor modalities, such as eddy current, where intimate sensor contact with the tube may improve sensor performance. Spring mechanism 325 allows scan head 330 and instrument 110 to be retracted from the surface of test object 130 as well as adjust for any frictional forces test object 130 may enact upon scan head 330 while scanning.

FIG. 31 shows a tube clamping mechanism 350. Tube clamping mechanism 350 may have a clamping pressure surface 351 and a pressure lever 352 so that the tubular test object 130 can be held in place during scanning. Clamping pressure surface 351 may be some material with the appropriate properties that, when appropriate pressure is applied, provides adequate friction and pressure to test object 130 to prevent movement of test object 130. Pressure lever 352 may be some mechanism to quickly and easily press clamping pressure surface 351 on to the surface of test object 130, thereby providing sufficient clamping force to prevent test object 130 movement, primarily rotational movement. This is to ensure the circumferential position of test object 130 that is being scanned by scan head 330 stays consistent throughout the scan motion.

In some embodiments, interior curved support 314 and exterior curved support 315 are offset by a fixed rotation amount (e.g., 90 degrees) such that an interior scan can first be performed, the test object 130 rotated the fixed amount, and then an exterior scan is performed (or vice versa). Such a technique may be used, for example, for an axial weld (e.g., a “seam weld”). A circumferential weld could be scanned, for example, simultaneously by both an interior sensor and an exterior sensor as test object 130 is rotated within scanner 300.

In some embodiments a false test object having similar geometry as test object 130 along the scan path is provided and abutted to test object 130. In this way scanning can continue off the edge of the part without for example, having encoder 103 become disengaged, or without having a flexible sensor change shape due to an edge.

In some embodiments, a computer executable code module contains computer code for monitoring and controlling the position of the sensor relative to a weld. The computer code may, for example take measurements from a sensing array and verify that at least one sensing element is on each side of a weld. For example, at least the first and last sensing elements of an array should be on “base” material distinguishable from the weld material by virtue of the sensor response. the computer executable code may control an actuator that shifts the sensor (or a structure/component the sensor is connected to) relative to the weld. This may be done at or prior to the start of a scan and/or continued throughout the scan to ensure the sensor stays centered on a weld.

In some embodiments the scanning system has a sensor that is scanned at + and −45 degrees to enhance detection of defects (e.g., cracks) at multi orientations. In some embodiments, automatic detection of crack defects is enhanced by utilizing tests on EDM notches on a test standard in at least 3 orientations to validate sensor inspection performance, alignment, and coverage.

In some embodiments, the system comprises a control module that limits the speed of actuators moving the sensor relative to the test object to achieve a minimum data density (e.g., a minimum of 10 points on a 30×15 mil EDM notch). In some embodiments, a shape filter signature library is generated from 2 EDM notch orientations and at least one EDM notch size. A precomputed database may be used to process data prior to use of shape filter to determine conductivity and liftoff at at least one sensor excitation frequency.

In some embodiments, encoder 103 is positioned at the center of array with respect to the scan direction. By positioning encoder 103 in such a way the system may be able to improve alignment and maintain at least one element on each side of a weld on base material.

In some embodiments, a flex cable is used to connect the sensor to the instrument, eliminating the need to attach any instrumentation to the scanning portion of the to scanner. This may reduce the likelihood of damage to the instrument 110. Also, in test objects having a small inner diameter, it may be impractical to put the instrumentation within the test object. The additional space may also be used to support addition sensor array channels. Further, the same instrument could be used for both interior and exterior scans.

Some additional features of the system may include: (i) a modular design that enables stretching in the axial direction that accommodates longer and shorter tubulars; (ii) a mounting mechanism for sensor includes means for moving in radial direction; (iii) a spring loaded to press sensor against the surface with an acceptable force in radial direction; (iv) foam backing behind sensor to improve uniformity of sensor liftoff relative to external surface of the tubular; (v) a software module for providing liftoff feedback to the operator to verify acceptable liftoff across the sensor and throughout each scan; (vi) a software module to provide conductivity feedback to verify metallurgical quality of base material and weld; (vii) a software module for providing conductivity maps used to verify full coverage of a seam weld; (viii) a software module to determine the thickness measurement across weld to verify thickness and weld quality; (ix) a combination of two of the following used to verify alignment of the tubular above and below the seam weld: (1) liftoff, (2) thickness, (3) conductivity; (x) a software module to provide liftoff feedback in real time during scanning to avoid wasting time during a poor scan or to detect a problem with the sensor or scanner; (xi) a software module to provide liftoff feedback to avoid damage to the tubular that might be caused by a failing sensor or scanning mechanism; (xii) a mounting mechanism that accommodates the sensor and at least a portion of the electronics; (xiii) inclusion of a base on which outside support and end plates are mounted to support the scanning system; (xiv) end plates are used with mounting rails to allow the sensor to move in the axial direction; (xv) end plates having multiple rail mounting positions to accommodate different tubular diameters; (xvi) a single computer is used to record data from the sensor and command (e.g., start/stop motion, target position, target distance) the motion of the sensor relative to the tubular; (xvii) encoder is used to measure the axial position; (xviii) encoder is used to measure the circumferential position; (xix) motors are used to move sensor in axial direction along the seam weld; (xx) motors are used to move the tubular item in circumferential direction to align the weld with the center of the sensor; (xxi) motors are used to move the tubular item in circumferential direction to shift positions from the inner support to the outer support; and (xxii) motors are used to move the sensor in the circumferential direction to align the weld with the center of the sensor. In some embodiments, a precomputed database is used to estimate liftoff and crack response independently. In some embodiments, a precomputed database accounts for the thickness of the thin tubular item; in some embodiments, shape filters are used to identify crack-like features with a threshold to detect cracks above a certain size.

### SECTION III—SCANNING SYSTEM FOR SOME OTHER AXIALLY SYMMETRIC TEST OBJECTS

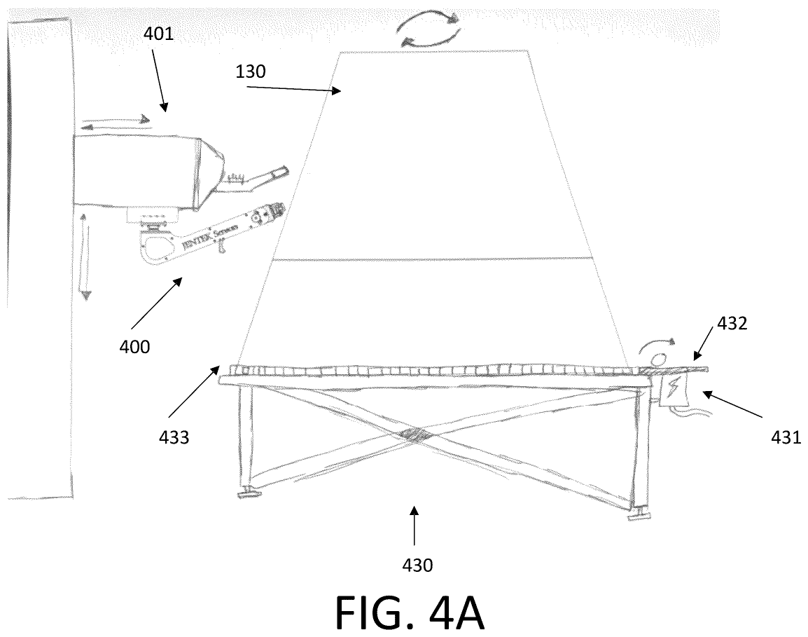

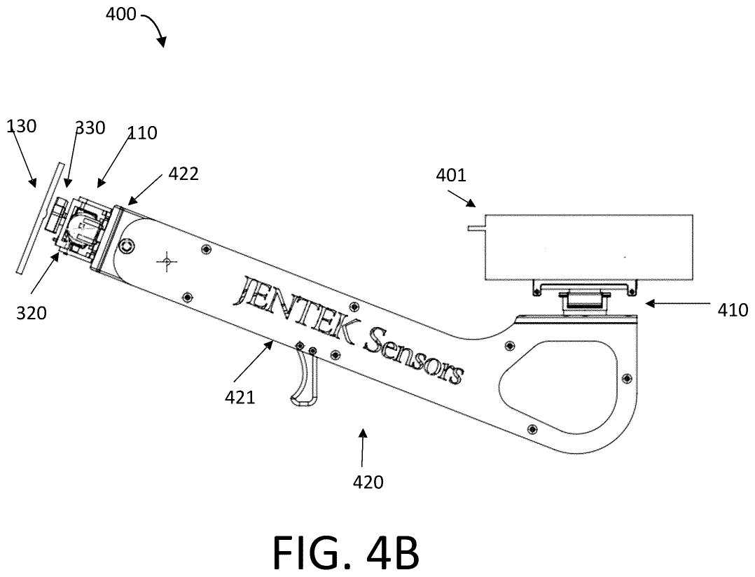

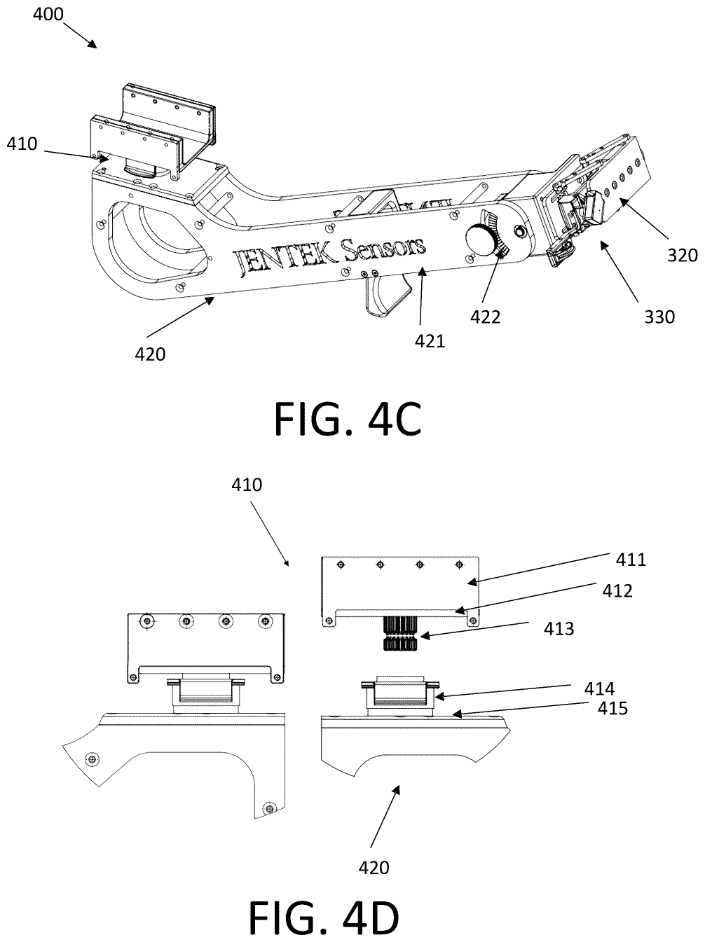

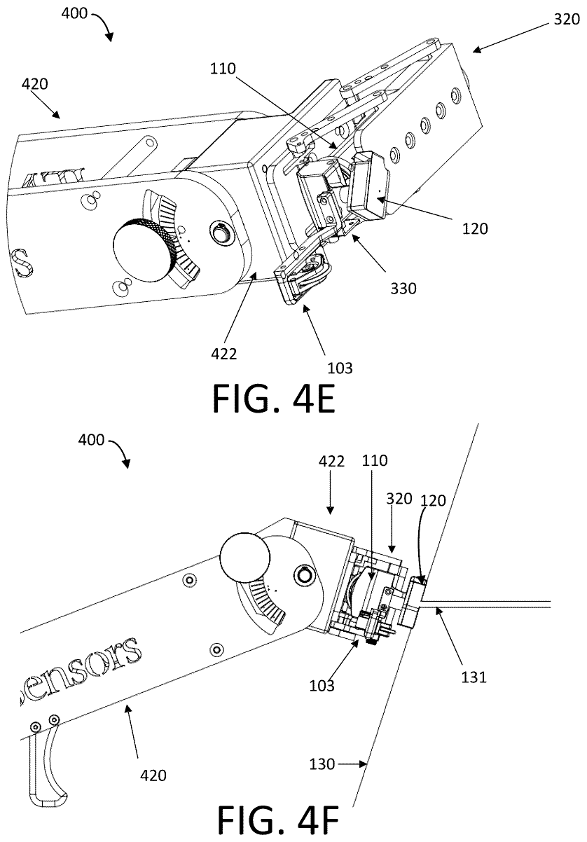

FIGS. 4A-4E show a scanner 400, according to some embodiments. Scanner 400 may be configured to support scanning of a test object 130 that has a curvature. Specifically, scanner 400 may be used to scan the outer surface of the test object 130.

FIG. 4A shows scanner 400 in contact with a test object 130. Scanner 400 may be designed for a maximum and minimum diameter, and a maximum out of roundness. Scanner 400 attaches to some mounting location 401. Mounting location 401 is some maximum distance from test object 130. In this embodiment, mounting location 401 is a motorized, translating arm that can bring nozzle scanner 400 to the surface of test object 130. Test object 130 is also mounted atop a rotating platform 430, which, using a rotational actuator 431, driving gear 432, and circumferential gear 433, allow for test object 130 to be rotated across scanner 400.

FIGS. 4B and 4C show scanner 400, according to some embodiments. Scanner 400 includes a main armature 420 to support the instrument 110. The length of main armature 420 may be chosen to accommodate variable distances between mounting location 401 and test object 130. Main armature 420 includes structural elements 421 that provide stability and rigidity across the distance between mounting location 401 and test object 130. Main armature 420 includes angle adjustment mechanism 422 so as to accommodate adjustments to instrument 110's angular position with respect to test object 130's surface. Scanner 400 includes an instrument holding apparatus 320 which affixes to angle adjustment mechanism 422 and supports instrument 110 while also providing compliance to the surface of test object 130.

FIG. 4D shows a mounting apparatus 410, according to some embodiments. Mounting apparatus 410 includes mounting plates 411 which may be permanently affixed to mounting location 401. Mounting apparatus 410 includes a quick release shaft 413 and quick release hub 414 which may be fabricated in such a way to allow rapid detachment and reattachment of the main armature 420 from the mounting location 401. An upper platform 412 may connect the quick release shaft 413 with the mounting plates 411, while a lower platform 415 may connect the quick release hub 414 with the main armature 420.

FIG. 4E shows a scan head 330 with a sensor 120 attached. Scan head 330 has an attached position encoder 103 to provide positional feedback during a scan. Scan head 330 along with sensor 120 are connected to instrument 110. Instrument 110 is secured to instrument holding apparatus 320.

FIG. 4F shows a view of scanner 400 scanning sensor 120 across a weld 131 on test object 130. In some embodiments, scanner 400 is used to inspect weld 131 on test object 130. U.S. Patent Publication No. 2005/0017713 A1, published Jan. 27, 2005 and herein incorporated by reference in its entirety.

### SECTION IV—CLOSING DISCUSSION

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

In this respect, it should be appreciated that one implementation of the above-described embodiments comprises at least one computer-readable medium encoded with a computer program (e.g., a plurality of instructions), which, when executed on a processor, performs some or all of the above-discussed functions of these embodiments. As used herein, the term “computer-readable medium” encompasses only a computer-readable medium that can be considered to be a machine or a manufacture (i.e., article of manufacture). A computer-readable medium may be, for example, a tangible medium on which computer-readable information may be encoded or stored, a storage medium on which computer-readable information may be encoded or stored, and/or a non-transitory medium on which computer-readable information may be encoded or stored. Other non-exhaustive examples of computer-readable media include a computer memory (e.g., a ROM, a RAM, a flash memory, or other type of computer memory), a magnetic disc or tape, an optical disc, and/or other types of computer-readable media that can be considered to be a machine or a manufacture.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

For the purposes of describing and defining the present disclosure, it is noted that terms of degree (e.g., “substantially,” “slightly,” “about,” “comparable,” etc.) may be utilized herein to represent the inherent degree of uncertainty that may be attributed to any quantitative comparison, value, measurement, or other representation. Such terms of degree may also be utilized herein to represent the degree by which a quantitative representation may vary from a stated reference (e.g., about 10% or less) without resulting in a change in the basic function of the subject matter at issue. Unless otherwise stated herein, any numerical values appeared in this specification are deemed modified by a term of degree thereby reflecting their intrinsic uncertainty. The “substantially simultaneous response” means responses measured within 1 second of one another.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Any materials that have been incorporated by reference are incorporated by reference herein in their entirety except as otherwise indicated specifically with respect to such material and only to the extent that the incorporated materials are not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claims is:

1. A scanning system for scanning a tubular test object having a tube wall with a plurality of diameter surfaces that include an inside diameter surface and an outside diameter surface, the scanning system comprising:
a first end support;
a second end support;
a curved support mechanically supported by the first and second end supports, and having a curved surface for supporting the tubular test object on at least one of the plurality of diameter surfaces;
a mounting rail mechanically supported by the first and second end supports and running parallel to the curved support; and
a sensor system holder mechanically supported by the mounting rail and movable along the mounting rail.

2. The scanning system of claim 1, wherein the curved surface of the curved support is a convex surface for supporting the tubular test object on the inside diameter surface.

3. The scanning system of claim 2, further comprising:
a sensor system at least a portion of which is mechanically supported by the sensor system holder, the at least a portion including a flexible sensor;
wherein
the mounting rail is mechanically supported by the first and second end supports such that the sensor system holder, in a first location, positions the flexible sensor opposite the curved surface of the curved support, such that during scanning operation a portion of the tube wall of the tubular test object is between the curved support and the flexible sensor.

4. The scanning system of claim 3, wherein
the curved surface is a convex curved surface positioned to provide support on the inside diameter surface of the tubular test object; and
the flexible sensor is positioned such that during scanning operation the flexible sensor scans on the outside diameter surface of the tube wall of the tubular test object.

5. The scanning system of claim 3, wherein
the curved surface is a concave curved surface positioned to provide support on the outside diameter surface of the tubular test object; and
the flexible sensor is positioned such that during scanning operation the flexible sensor scans on the inside diameter surface of the tube wall of the tubular test object.

6. The scanning system of claim 1, wherein
the curved support is a first curved support; and
the first curved surface is a convex curved surface positioned to provide support on the inside diameter surface of the tubular test object;
the scanning system further comprising:
a second curved support mechanically supported by the first and second end supports and running parallel to the first curved support, the second curved support positioned to provide support on the outside diameter surface of the tubular test object.

7. The scanning system of claim 6, wherein the first curved support and the second curved support are positioned such that the convex curved surface and the concave curved surface are concentric about an axis; the sensor system holder is a first sensor system holder; the mounting rail is a first mounting rail; and the first mounting rail supports the first sensor system holder at a larger radial distance from the axis than the convex curved surface; the scanning system further comprising:
a second mounting rail mechanically supported by the first and second end supports and running parallel to the second curved support; and
a second sensor system holder mechanically supported by the second mounting rail and movable along the second mounting rail, the second sensor system holder supported by the second mounting rail at a smaller radial distance from the axis than the concave curved surface.

8. The scanning system of claim 1, wherein the curved surface of the curved support is substantially radially symmetric such that a radial axis is defined; the scanning system further comprising:
a clamp mechanically supported by the first and second end supports, the clamp having a stationary portion at a smaller radial position about the radial axis and a sliding portion at a larger radial position about the radial axis.

9. The scanning system of claim 8, wherein
the first and second end supports each have a flat surface substantially within a same plane defining a bottom of the scanning system;
the radial axis is offset from the plane; and
the clamp is positioned between 30 and 90 degrees about the radial axis where 0 degrees is defined by a line normal to the plane and intersecting the radial axis.

10. (canceled)

11. A method of inspecting a tubular test object having a tube wall with a plurality of diameter surfaces, the method comprising acts of:
(i) providing a scanning system having
a first end support;
a second end support;
a curved support mechanically supported by the first and second end supports, and having a curved surface;
a mounting rail mechanically supported by the first and second end supports and running parallel to the curved support;
a sensor system holder mechanically supported by the mounting rail and movable along the mounting rail; and
a sensor system at least a portion of which is mechanically supported by the sensor system holder, the at least a portion including a flexible sensor;
(ii) loading the scanning system with the tubular test object such that the curved support supports the tubular test object on a first diameter surface among the plurality of diameter surfaces and a portion of the tube wall in contact with the curved support is between the flexible sensor and the curved support; and
(iii) measuring with the sensor system while scanning the flexible sensor along a second diameter surface among the plurality of diameter surfaces, the second diameter surface different from the first diameter surface.

12. The method of claim 11, wherein
the curved surface is a convex curved surface;
the first diameter surface is an inside diameter surface of the tubular test object; and
the second diameter surface is an outside diameter surface of the tubular test object.

13. The method of claim 11, wherein
the curved surface is a concave curved surface;
the first diameter surface is an outside diameter surface of the tubular test object; and
the second diameter surface is an inside diameter surface of the tubular test object.

14. (canceled)

15. (canceled)

16. The method of claim 11, wherein
the flexible sensor is a flexible eddy current array;
the sensor system includes an eddy current array instrument operably connected to the flexible eddy current array;
the sensor system holder applies a force to press the flexible eddy current array against the second diameter surface; and
the curved support provides an opposite force to prevent radial deformation of the test object during act (iii).

17. The method of claim 11, wherein
the flexible sensor is a flexible eddy current array having a drive winding and an array of sense windings, the drive winding having a linear portion, and a drive-sense gap is defined as the minimum distance between the linear portion of the drive winding and the array of sense windings; the method further comprising:
(iv) processing measurements from the flexible sensor to estimate a plurality of properties including liftoff; and
(v) filtering out measurements collected at locations where the sensor liftoff exceeds the drive-sense gap.

18. (canceled)

19. (canceled)

20. The method of claim 11, wherein the act (i) of providing the scanning system comprises providing a second mounting rail, a second sensor system holder, and a second sensor system;
and wherein the act (iii) further comprises measuring and scanning with the second sensor system on the first diameter surface.

21. The method of claim 11, wherein the act (ii) of loading the scanning system with the tubular test object comprises clamping the tubular test object with a clamp having a stationary portion within an inside diameter of the tubular test object a sliding portion at an outside diameter of the tubular test object.

22. (canceled)

23. The method of claim 22, wherein the flexible sensor is a flexible eddy current array having an array of sense element; and the act (iii) comprises positioning the flexible eddy current array on the seam weld such that the array of sense elements spans a width of the seam weld and positions sense elements on base material on each side of the seam weld.

24. The method of claim 11, wherein the flexible sensor is a flexible eddy current array;
the sensor system includes an eddy current array instrument operably connected to the flexible eddy current array; and the act (iii) comprises exciting the flexible eddy current array with the eddy current array instrument at an excitation frequency such that a skin depth at the excitation frequency at a location on the tubular test object being measured by the flexible eddy current array is less than a wall thickness of the tube wall at the location.

25. The method of claim 11, wherein the flexible sensor is a flexible eddy current array having a linear drive construct; and act (iii) comprises orienting the linear drive construct at 45 degrees relative to a direction of scanning, the method further comprising rotating the flexible eddy current array such that the linear drive construct is oriented at minus 45 degrees relative to the direction of scanning and repeating acts (iii) and (iv).

26. An apparatus for holding a eddy current sensor in proximity to a welded sample, the apparatus comprising:
an eddy current instrument with a connector at one end;
a holder for the eddy current instrument;
a mounting arm with a first mechanical connector for attaching the holder on one end a second mechanical connector for connecting to a structure that is separate from the welded sample;
an eddy current array having at least three sensing elements, the eddy current array operably connected to the eddy current instrument, wherein the eddy current array scan width is larger than the weld width;
a first mechanism for adjusting the eddy current array to be substantially tangent to a surface of the welded sample;
a module for determining, at a start of a scan, that at least one sensing element on each end of the eddy current array is sensing base material outside of a weld on the welded sample; and
a second mechanism for moving the eddy current array instrument away from the sample to enable welding to be performed on the welded sample, where the second mechanism enables the eddy current instrument and the eddy current array to be at a distance from the welding process sufficient to avoid damage from the welding process.

27-43. (canceled)
